(19) United States
(12) Patent Application Publication
(10) Pub. No.: US 2006/0282464 A1
(43) Pub. Date: Dec. 14, 2006

(54) Multi-dial system for inter-channel surfing of digital media files

(76) Inventor: Charles Albert Morris, Maquoketa, IA (US)

Correspondence Address: Charles A. Morris, 612 S. 2nd St., Maquoketa, IA, 52060, US

(21) Appl. No.: 11/150,081

(22) Filed: Jun. 10, 2005

(51) Int. Cl. G06F 7/00

(52) U.S. Cl. 707/104.1

(57) ABSTRACT

The present invention is a system for organizing and providing intuitive access to the widest range of digital media documents. The system allows users to both register and access listings of media documents by setting the channels on multiple graphic dials. Each dial provides a full spectrum of possible media document attributes. Separate dials offer quick selection of the following media document attributes: media type, genre of the media document, tone expressed in the media document, subject addressed in the media document, activity addressed in the media document, and theme addressed in the media document. Users can activate and set as many dials as they like to specify the sort of works they wish to register into the database or access through the database. Users of the system can register a new media document in the database by first listing the location of the document and then by setting the dials to the channels that best describe the document. When accessing media documents, changing the channel on any one of the dials brings up a new list of matching works available through the database. Users then click on a specific listing to access the document. When registering new media documents or when accessing media documents already registered in the database, users can select multiple channels on any dial to describe the documents. Users can also select categories from subsets that are offered on many of the channels.

### BACKGROUND OF THE INVENTION

The present invention relates to organizing diverse types of media documents provided over computer networks such as the Internet and particularly to a system for easily accessing such media documents.

Standard search engines do not provide Internet users the ability to fluidly surf the diverse media available on-line. Search results quite often offer cumbersomely long lists of links to media documents and web sites that only somehow relate to the subject entered in the search. The lists often include documents and sites that address the subject from many points of view, but these points of view are not represented in the search results. If a user wishes to surf related subjects, he or she might sometimes happen upon a link to this related subject on a web page found through the search, but the search engine itself does not offer links to documents and pages that address related subjects. Instead, the user must begin a new search. For example, if a user wishes to explore how a subject is addressed in different genres, a separate search is required for each genre.

In the prior art, various approaches to organizing and presenting diverse types of media documents have been proposed. In U.S. Pat. No. 6,577,714, a map-based directory service is disclosed. Users are presented with a map on a computer screen, the map having symbols indicating real-world locations such as buildings, streets, parks, and bodies of water. The map also includes symbols for entities that have no physical presence in the real world but that are in some way related to the real-world locations. All of the symbols provide links connecting to the media documents associated with those symbols. Such a method provides intuitive access to multiple categories of media documents, but limits the categories to media document that directly address specific geographic locations and media documents that are symbolically linked to specific geographic locations.

In U.S. Pat. No. 6,311,194 a semantic-based system for creating a database of metadata of media documents is disclosed. By capturing metadata of media documents and by using semantics analysis this system is meant to determine the specific meaning and intended use of the media document. The success of such a system would be limited by the unpredictability of metadata attached to media documents. Furthermore, this system does not define fields of categories that might be used by media document creators in the metadata.

In U.S. Pat. No. 5,634,051, an information storage, searching and retrieval system is described. The system sorts media documents by unspecified categories or types and emphasizes customization, allowing the user to determine the categories or types. Such an open-ended system demands too much work of the average Internet user, requiring them to define all categories and types in order to store, search, and retrieve media documents.

In U.S. Pat. No. 6,874,152 a database system that adds genre codes and content descriptions to listings for media documents is described. The content descriptions allow the user to employ a standard search engine to find subject matter of interest, and the genre code adds one dimension of categorization. However, the genre codes are not presented in any structured format and would have to be selected from some sort of list that is not specified by the inventor. Furthermore, presenting the single category of genre does not allow the user to fluidly surf inter-dimensionally through such fields as subject, theme, tone, activity, or media format.

In U.S. Pat. No. 6,037,944 a system for organizing categories of media documents is disclosed. A graphical representation of a network of categories is displayed, with display icons for each category and connecting lines between the display icons corresponding to the relationships among the categories. When a new category is chosen, a graphical representation of a new network of categories is generated offering categories related to the newly chosen category. Such a system points to related categories, but the related categories are presented in an unstructured manner.

We see that a category has a relationship with each of the many categories arrayed around it and connected by lines, but we must decipher for ourselves what those relationships are, and we are forced to read entire lists of unstructured categories to see if a desired category exists there.

### BRIEF SUMMARY OF THE INVENTION

It is an object of the invention to provide a system for organizing, searching, and accessing diverse types of media documents provided over computer networks such as the Internet by allowing users to both register media documents and to access listings of registered media documents by setting the channels on multiple graphic dials, with each dial providing a full spectrum of possible media document attributes. Users of the system can register a new media document in the database by first listing the location of the document and then by setting the dials to the channels that best describe the document. When accessing media documents, changing the channel on any one of the dials brings up a new list of works that have been registered with the same plurality of channels that have been selected on the dials. Users then click on a specific listing to access the document.

It is a further object of the invention to provide dials offering quick selection of the following media document attributes: media type, genre of the media document, tone expressed in the media document, subject addressed in the media document, activity addressed in the media document, and theme addressed in the media document.

It is a further object of the invention to allow users to activate and set as many dials as they like to specify the sort of works they wish to register with the database or access through the database.

It is a further object of the invention to allow users to select multiple channels on any dial to describe the documents.

It is a further object of the invention to allow users to also select more specific categories from listed subsets that are offered on many of the channels.

It is a further object of the invention to allow users to conduct a standard textual search in order to further specify the type of media documents desired.

It is a further object of the invention to allow the system to be coupled with a filesharing program that will legally share only those media documents that have been registered by their creators.

### BRIEF DESCRIPTION OF THE SEVERAL VIEWS OF THE DRAWING

The present invention will be more fully understood by reference to the following detailed descriptions thereof when read in conjunction with the attached drawings, and wherein:

FIG. 1 is a graphical representation of a master dial 101 with six icons for field dials 102-107 arrayed around the master dial 101 and a selection query presenting the user with options to “Access Media” 108 and two methods to “Register Media” 109 and 110.

FIG. 2 is a graphical representation of an opened Media field dial 201 with a circular field of media channels 202 arrayed around the opened Media field dial 201 and with a list of media sub-channels 205 related to a highlighted media channel 203. A list of “Current Channels” 207 shows the channels selected on each dial. Three buttons offer options to “Tip” 213, “Purchase” 214, or “Rate” 215 a currently selected file. A “Rate” pop-up window 221 offers options to rate a currently selected file with zero to five stars. Three check boxes 210-212 offer three methods for ranking the listings of files. A “Matching Files” box 219 lists files that match settings on the dials. The user can click on a button 216 to access listings of matching files in his or her personal library. The user can click on a button 217 to add the currently selected file to his or her personal library. The user can enter text in a search field 218 to access files containing the entered text.

FIG. 3 is a graphical representation of an opened Genre field dial 301 with a circular field of genre channels 302 arrayed around the opened Genre field dial 301.

FIG. 4 is a graphical representation of an opened Tone field dial 401 with a circular field of tone channels 402 arrayed around the opened Tone field dial 401.

FIG. 5 is a graphical representation of an opened Activity field dial 501 with a circular field of activity channels 502 arrayed around the opened Activity field dial 501.

FIG. 6 is a graphical representation of an opened Theme field dial 601 with a circular field of media channels 602 arrayed around the opened Theme field dial 601.

FIG. 7 is a graphical representation of an opened Subject field dial 701 with a circular field of subject channels 702 arrayed around the opened Subject field dial 701.

FIG. 8 illustrates a flow chart describing one method of adding data to and accessing data from the database 801 and directing users 807, 808 to media documents 804.

FIG. 9 illustrates a flow chart describing one method of adding data to and accessing data from the database 901, directing users 904 to media documents 907, and allowing media documents 907 to be shared between users.

### DETAILED DESCRIPTION OF THE INVENTION

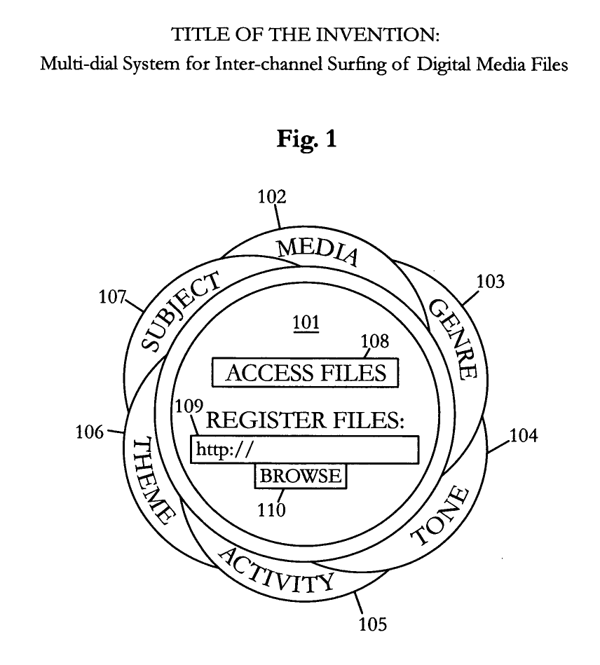

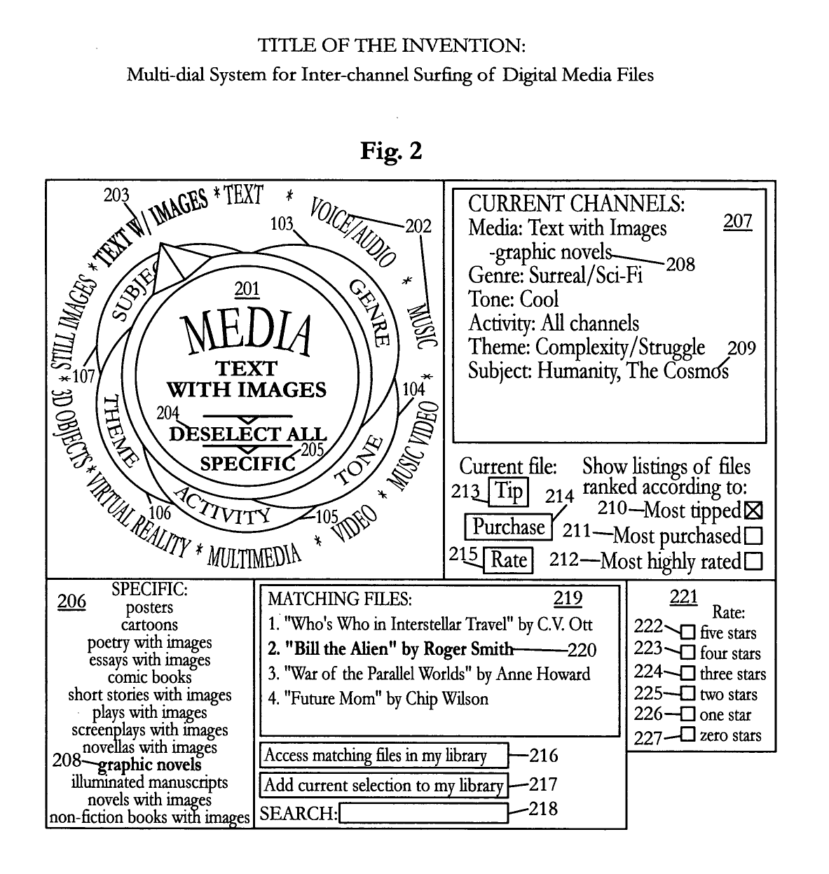

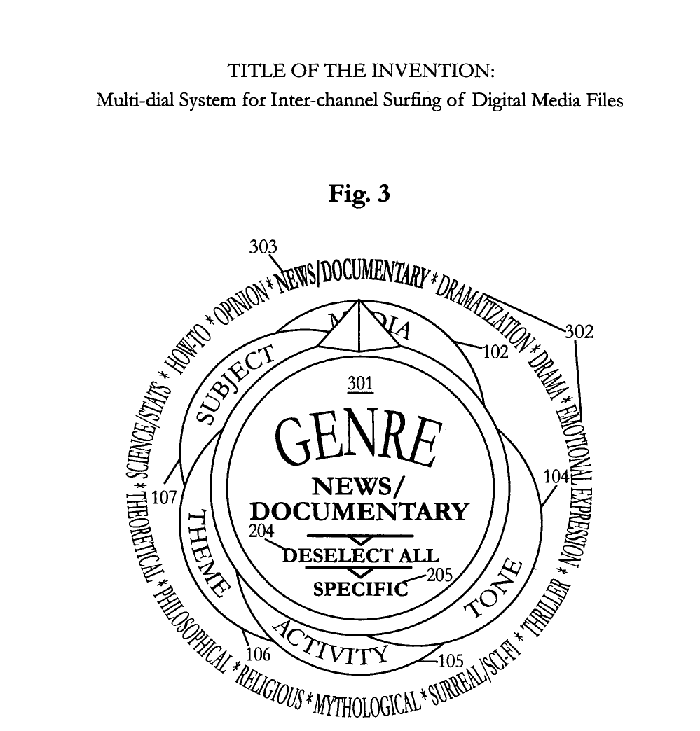

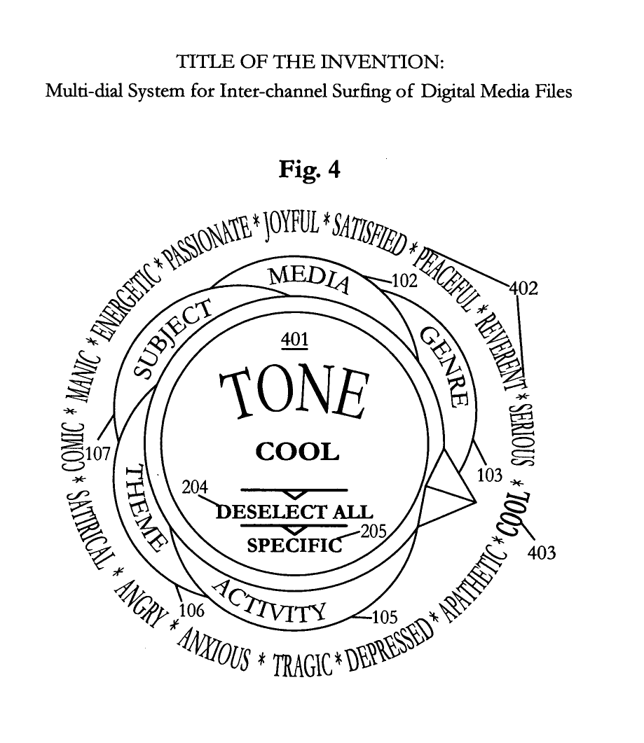

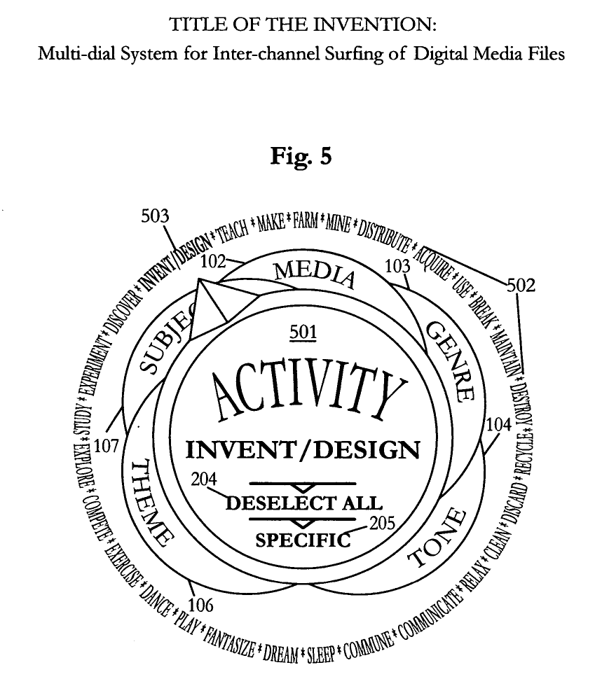

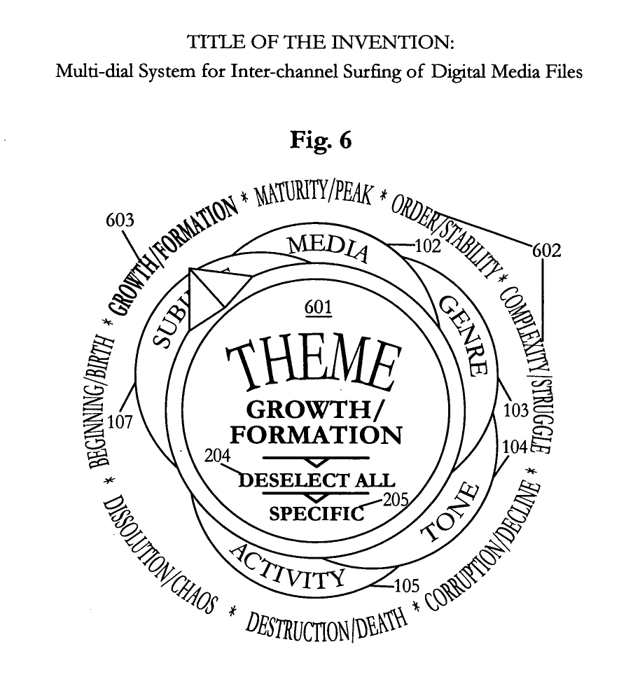

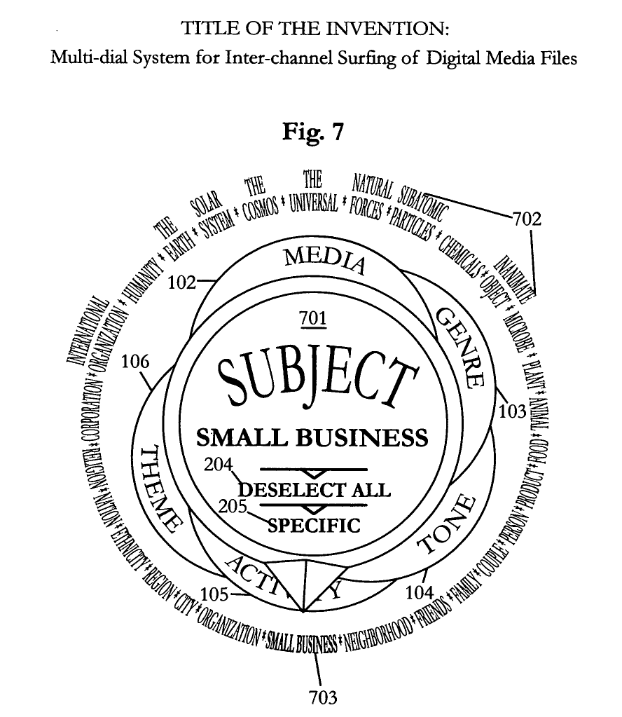

In FIG. 1, there is shown an overview of a master dial 101 with six field dials 102-107 arrayed around the master dial 101. The master dial 101 is the initial graphical image presented to the user when the user wishes to either register a new media document within the system or when the user wishes to access a media document already registered within the system. The user is presented with two options: “Access Files” 108 and “Register Files”. The user is presented with two options for registering media documents: the user can fill in a URL field 109 or can “Browse” 110 to select a media document to be registered. After the user has selected “Access Files” 108 or has selected the media document to be registered, he or she can click on an icon for one of the field dials 102-107 to begin selecting channels. When a user clicks on an icon for one of the field dials 102-107, the graphical image changes to the corresponding opened field dial 201 in FIG. 2, 301 in FIG. 3, 401 in FIG. 4, 501 in FIG. 5, 601 in FIG. 6, or 701 in FIG. 7.

When the user has accessed the “Media” field dial 201 in FIG. 2, a field of media channels 202 is displayed, arrayed around the Media field dial 201. The user can then use a scroll wheel to scroll continuously, clockwise and counterclockwise, around the field of media channels 202, thereby highlighting media channels and can click to select a highlighted media channel 203. The user can continue scrolling through the Media field dial 201 and clicking to select multiple media channels from the field of media channels 202. The user can deselect all selected media channels on the dial by clicking on the “Deselect All” icon 204. In order to switch to one of the other field dials 301 in FIG. 3, 401 in FIG. 4, 501 in FIG. 5, 601 in FIG. 6, or 701 in FIG. 7, the user clicks on one of the icons for the field dials 103-107.

Further methods for specifying the type of media documents a user wishes to register or access are shown in FIG. 2 and apply similarly to all opened field dials 301 in FIG. 3, 401 in FIG. 4, 501 in FIG. 5, 601 in FIG. 6, or 701 in FIG. 7. The illustration of these methods, shown in FIG. 2, are as follows: A.) The user can click on the “Specific” icon 205 within the Media field dial 201 in order to access a list of sub-channels 206 of the highlighted media channel 203. By clicking on and highlighting a specific sub-channel 208, the user can further specify the type of media documents he or she would like to access. A “Current Channels” box 207 shows which channels have been selected on each dial. Each specific sub-channel 208 selected is also shown in the “Current Channels” box 207. Each listing of multiple channels on any single dial 209 is also shown in the “Current Channels” box 207. B.) Users can click on a “Show listings of files ranked according to: Most tipped” box 210 in order to view listings of matching media documents 219 ranked according to the amount of tips given to the media creator in appreciation for a listed media document. C.) Users can click on a “Show listings of files ranked according to: Most purchased” box 211 in order to view listings of matching media documents 219 ranked according to the number of media documents that have been purchased. D.) Users can click on a “Show listings of files ranked according to: Most highly rated” box 211 in order to view listings of matching media documents 219 ranked according to ratings received from users. The user can participate in affecting the ratings by clicking on the “Current file: Tip” box 213 in order to access an on-line service that will transfer a monetary sum from the user to the creator of the media document. The user can participate in affecting the ratings by clicking on the “Current file: Purchase” box 214 in order to access an on-line service that will allow the user to pay to download or receive a hard copy of the media document. The user can participate in affecting the ratings by clicking on the “Current file: Rate” box 215 in order to open a rating dialogue box 221 that allows the user to give the media document a rating from zero to five stars by clicking on one of the rating boxes 222-227. E.) The user can click on one of the matching media documents listed as one of the “Matching Files” 219 to make it the current selection 220 and to access the media document. F.) The user can access listings of “Matching Files” 219 that have been saved in a personal library by clicking on the “Access matching files in my library” button 216. In order to save a current selection 220 to the personal library, the user clicks on the “Add current selection to my library” button 217. G.) The user can enter text for a textual search in the search field 218 in order to access listings of media documents that contain the text entered in the search field 218.

When the user has accessed the “Genre” field dial 301 in FIG. 3, the field of genre channels 302 is displayed, arrayed around the Genre field dial 301. The user can then use a scroll wheel to scroll continuously, clockwise and counterclockwise, around the field of genre channels 302, thereby highlighting genre channels and can click to select the highlighted genre channel 303. The user can then continue scrolling and clicking to select multiple genre channels from the field of genre channels 302. The user can deselect all selected genre channels by clicking on the “Deselect All” icon 204. The user can click on the “Specific” icon 205 in order to access a list of sub-channels of the highlighted genre channel 303. In order to switch to one of the other field dials 201 in FIG. 2, 401 in FIG. 4, 501 in FIG. 5, 601 in FIG. 6, or 701 in FIG. 7, the user clicks on one of the icons for the field dials 102, 104-107.

When the user has accessed the “Tone” field dial 401 in FIG. 4, the field of tone channels 402 is displayed, arrayed around the Tone field dial 401. The user can then use a scroll wheel to scroll continuously, clockwise and counterclockwise, around the field of tone 402, thereby highlighting tone channels and can click to select the highlighted tone channel 403. The user can then continue scrolling and clicking to select multiple tone channels from the field of tone channels 402. The user can deselect all selected tone channels by clicking on the “Deselect All” icon 204. The user can click on the “Specific” icon 205 in order to access a list of sub-channels of the highlighted genre channel 403. In order to switch to one of the other field dials 201 in FIG. 2, 301 in FIG. 3, 501 in FIG. 5, 601 in FIG. 6, or 701 in FIG. 7, the user clicks on one of the icons for the field dials 102, 103, 105-107.

When the user has accessed the “Activity” field dial 501 in FIG. 5, the field of activity channels 502 is displayed, arrayed around the Activity field dial 501. The user can then use a scroll wheel to scroll continuously, clockwise and counterclockwise, around the field of activity channels 502, thereby highlighting activity channels and can click to select the highlighted activity channel 503. The user can then continue scrolling and clicking to select multiple activity channels from the field of activity channels 502. The user can deselect all selected activity channels by clicking on the “Deselect All” icon 204. The user can click on the “Specific” icon 205 in order to access a list of sub-channels of the highlighted genre channel 503. In order to switch to one of the other field dials 201 in FIG. 2, 301 in FIG. 3, 401 in FIG. 4, 601 in FIG. 6, or 701 in FIG. 7, the user clicks on one of the icons for the field dials 102-104, 106, 107.

When the user has accessed the “Theme” field dial 601 in FIG. 6, the field of theme channels 602 is displayed, arrayed around the Theme field dial 601. The user can then use a scroll wheel to scroll continuously, clockwise and counterclockwise, around the field of theme channels 602, thereby highlighting theme channels and can click to select the highlighted theme channel 603. The user can then continue scrolling and clicking to select multiple theme channels from the field of theme channels 602. The user can deselect all selected theme channels by clicking on the “Deselect All” icon 204. The user can click on the “Specific” icon 205 in order to access a list of sub-channels of the highlighted genre channel 603. In order to switch to one of the other field dials 201 in FIG. 2, 301 in FIG. 3, 401 in FIG. 4, 501 in FIG. 5, or 701 in FIG. 7, the user clicks on one of the icons for the field dials 102-105, 107.

When the user has accessed the “Subject” field dial 701 in FIG. 7, the field of subject channels 702 is displayed, arrayed around the Subject field dial 701. The user can then use a scroll wheel to scroll continuously, clockwise and counterclockwise, around the field of subject channels 702, thereby highlighting subject channels and can click to select the highlighted subject channel 703. The user can then continue scrolling and clicking to select multiple subject channels from the field of subject channels 702. The user can deselect all selected subject channels by clicking on the “Deselect All” icon 204. The user can click on the “Specific” icon 205 in order to access a list of sub-channels of the highlighted genre channel 703. In order to switch to one of the other field dials 201 in FIG. 2, 301 in FIG. 3, 401 in FIG. 4, 501 in FIG. 5, or 601 in FIG. 6, the user clicks on one of the icons for the field dials 102-106.

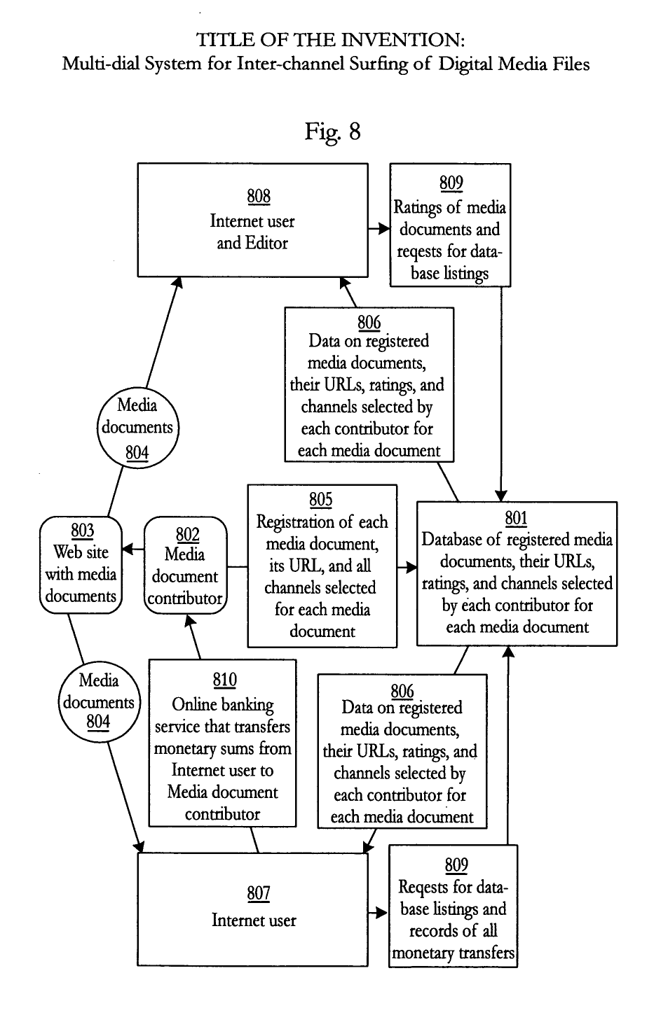

FIG. 8 illustrates a flow chart describing one method of adding data to and accessing data from the database 801 and directing users 807, 808 to media documents 804. A media document contributor 802 sends a registration 805 for each of the media documents 804, including the URL of the media documents 804 (indicating the web site 803 that holds the media documents 804), and all channels selected (using the methods described above in FIG. 1 and FIG. 2) for each of the media documents 804 to a database 801 that maintains data on each of the registered media documents 804, its URL, its rating, and all channels, including sub-channels, selected by each media document contributor 802 for each of the media documents 804. Internet users 807, 808 send requests for database listings 809 to the database 801 (using the methods described above and shown in FIG. 1 and FIG. 2) for specifying the types of media documents 804 they would like to access. The database then sends data 806 on each of the matching media documents 804, its URL, its rating, and the channels selected by each media document contributor 802 for each of the media documents 804. Internet users 807, 808 use the data 806 to select from listings of matching media documents 804 to retrieve the media documents 804 from the web site 803. Internet user 807 uses the on-line banking service 810 to transfer monetary sums to the media document contributor 802 in order to purchase goods from the media document contributor 802 or to tip the media document contributor 802. Records of all monetary transfers 809 sent through the on-line banking service 810 are automatically sent from the Internet user 807 to the database 801. An Internet user who also act as an editor 808 sends ratings 809 for at lest one of the media documents 804 to the database 801. The Internet users 807, 808 can access data on ratings 806 for each of the registered media documents 804.

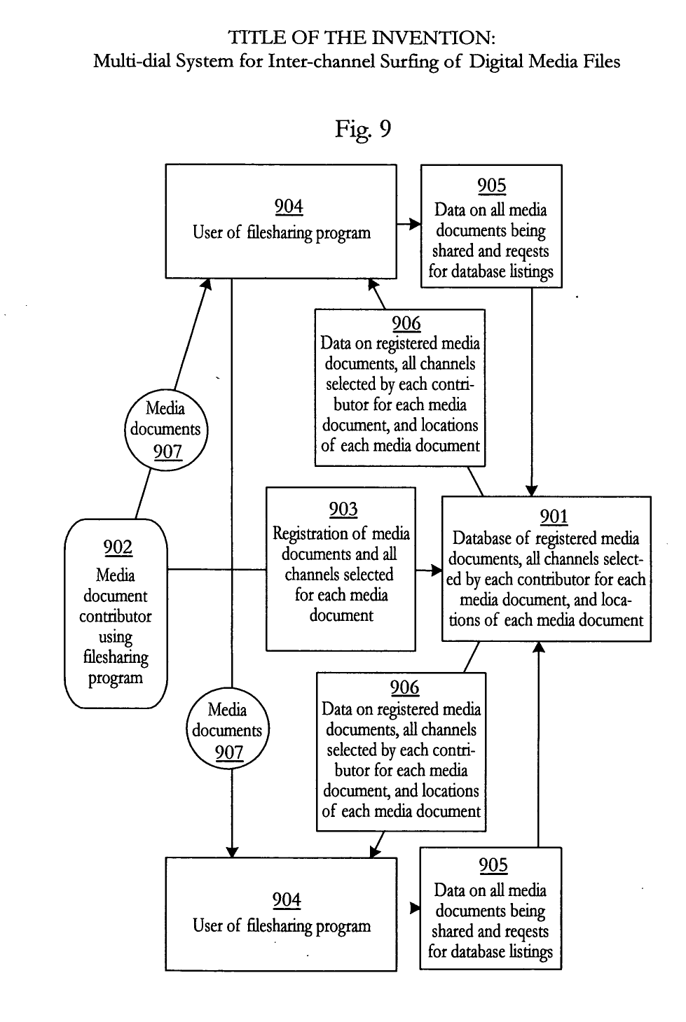

FIG. 9 illustrates a flow chart describing one method of adding data to and accessing data from the database 901 in order to direct users of a filesharing program 904 to media documents 907, and in order to allow legally registered media documents 907 to be shared between media document contributors 902 and users of the filesharing program 904. Media document contributors 902 using the filesharing program send a registration 903 of media documents 907 and all channels selected (using the methods described above and shown in FIG. 1 and FIG. 2) for all media documents 907 to a database 901 that maintains data on registered media documents 907, the locations of all users of the filesharing program 902 and 904 that are sharing media documents 907, the media documents 907 that each user of the filesharing program 902 and 904 are sharing, and all channels, including sub-channels, selected by each media document contributor 902 for each of the media documents 907. Users of the filesharing program 904 send data 905 on all media documents 907 that they are sharing, and they send requests for database listings 905 to the database 901 (using the methods described above in FIG. 1 and FIG. 2) for specifying the types of media documents 907 they would like to access. The database then sends data 906 on registered media documents 907, the locations of each user of the filesharing program 902 and 904 that have each of the media documents 907, and all channels selected by each media document contributor 902 for each of the media documents 907. Users of the filesharing program 904 use the data 906 to select from listings of matching media documents 907 to retrieve the media documents 907 from media document contributors 902 and from users of the filesharing program 904.

I claim:

1. an application for categorizing and accessing media documents stored on a computerized system including in combination:
a database;
means for at least one user of said application, using a logging mode of said application, to log within said database the location of at least one media document stored on said computerized system;
means for allowing said at least one user, using said logging mode of said application, to select at least one category for the categorization of each said media document through the use of a plurality of graphic dials, each said dial offering a distinct set of categories from which to choose, each said set of categories forming a continuous loop, each said category being a distinct category for the listing of media documents;
means for logging within said database each said at least one category selected by the said at least one user for the categorization of each said at least one media document;
means for allowing at least one user, using an accessing mode of said application, to select at least one category from the said plurality of dials in order to access a listing of those said media documents logged within said database that have been categorized with the same at least one said category;
and
means for providing said at least one user of said application, using the said accessing mode of said application, a link from each said listing of a said media document to the corresponding said media document stored within said computerized system, such that the link can be activated in order to access and open said media document.

2. The combination according to claim 1 wherein said at least one user of said application can choose said at least one category from the said plurality of dials and leave any number of said dials inactive, thereby accessing listings of those said media documents logged within said database that have been categorized with the same at least one said category and any other categories found on the said inactive dials.

3. The combination according to claim 1 wherein said at least one user can activate a particular dial by clicking on said dial and can then use a scroll wheel to scroll through said dial continuously and uninterrupted, scrolling clockwise and counterclockwise around the dial until stopping on a desired category in order to select that category.

4. The combination according to claim 1 wherein said at least one user can activate a particular dial by clicking on said dial, thereby opening a pop-up list of categories from which said at least one user can select at least one category by clicking on said at least one category.

5. The combination according to claim 1 wherein said at least one user, having selected said at least one category, can deselect said at least one category through a deselection operation such as at least one of the following group: a mouse click on said at least one category that has been selected and a mouse click on a deselect icon.

6. The combination according to claim 1 wherein at least one said category, once selected, allows said at least one user the option of selecting at least one sub-category by offering choices from at least one subset of at least one sub-category.

7. The combination according to claim 1 wherein the said dials include dials that categorize at least one of the following: the media format of media documents, the genres of media documents, the subjects addressed in media documents, the tones expressed in media documents, the activities addressed in media documents, the themes addressed in media documents.

8. The combination according to claim 1 wherein one of the said dials includes categories that specify the media formats of media documents;
and wherein the circular progression of categories for the said dial that specifies the media formats of media documents includes categories such as the following: text, voice/audio, music, music/video, video, multimedia, virtual reality, 3D objects, still images, text with images, and back to text.

9. The combination according to claim 1 wherein one of the said dials includes categories that specify genres of media documents;
and wherein the circular progression of categories for the said dial that specifies genres of media documents includes categories such as the following: news/documentary, dramatization, drama, emotional expression, thriller, surreal/sci-fiction, mythological, religious, philosophical, theoretical, science/statistics, how-to, opinion, and back to news/documentary.

10. The combination according to claim 1 wherein one of the said dials includes categories that specify tones expressed in media documents;
and wherein the circular progression of categories for the said dial that specifies tones expressed in media documents includes categories such as the following: comic, manic, energetic, passionate, joyful, satisfied, peaceful, reverent, serious, cool, apathetic, depressed, tragic, anxious, angry, satirical, and back to comic.

11. The combination according to claim 1 wherein one of the said dials includes categories that specify subjects addressed in media documents;
and wherein the circular progression of categories for the said dial that specifies subjects addressed in media documents includes categories such as the following: the universal, natural forces, subatomic particle, chemicals, inanimate object, microbe, plant, animal, food, product, person, couple, family, friends, neighborhood, small business, organization, city, region, ethnicity, nation, religion, corporation, international organization, humanity, the earth, the solar system, the cosmos, and back to the universal.

12. The combination according to claim 1 wherein one of the said dials includes categories that specify activities addressed in media documents;
and wherein the circular progression of categories for the said dial that specifies activities addressed in media documents includes categories such as the following: sleep, dream, fantasize, play, dance, exercise, compete, explore, study, experiment, discover, invent/design, teach, make, farm, mine, distribute, acquire, use, break, maintain, destroy, recycle, discard, clean, relax, communicate, commune, and back to sleeping.

13. The combination according to claim 1 wherein one of the said dials includes categories that specify themes addressed in media documents;
and wherein the circular progression of categories for the said dial that specifies themes addressed in media documents includes categories such as the following: beginning/birth, growth/formation, maturity/peak, order/stability, complexity/struggle, corruption/decline, destruction/death, dissolution/chaos, and back to beginning/birth.

14. The combination according to claim 1 wherein said computerized system is a shared network such as the Internet;

15. The combination according to claim 1 wherein said computerized system is a shared network such as the Internet;
and wherein said media documents can be copied from one computer within said computerized system to another computer within said computerized system;
and wherein said database maintains listings of all computers within said computerized system that have a copy of any given said media document;
and wherein any said given media document can be accessed from a plurality of computers within said computerized system.

16. The combination according to claim 1 wherein said computerized system is an individual computerized device.

17. The combination according to claim 1 wherein at least one user can add ratings to the database listing of at least one media document;
and wherein said ratings indicate at least one quality of said at least one media document such as at least one of the following group: excellence, age appropriateness, educational value, and cultural value;
and wherein at least one user, using the said accessing mode of said application, can access at least one said listing arranged according to said ratings.

18. The combination according to claim 1 wherein at least one user can add ratings to the database listing of at least one media document;
and wherein said ratings indicate at least one quality of said at least one media document such as at least one of the following group: excellence, age appropriateness, educational value, cultural value;
and wherein at least one user, using the said accessing mode of said application, can access at least one said listing that excludes any media document that has not been given a particular said rating.

19. The combination according to claim 1 wherein means are provided to allow at least one user to save at least one said link within a personalized database, such that, when using said accessing mode, said at least one user can access listings of personally saved links, including said saved links that have categories matching the categories on the said dials selected by the said at least one user.

20. The combination according to claim 1 wherein means are provided for said at least one user to electronically transfer monetary funds to at least one copyright holder of at least one said media document,
and wherein said database records all such said transfers of monetary funds,
and wherein at least one user, using the said accessing mode of said application, can access at least one said listing arranged according to amount of said transfers of monetary funds sent to each copyright holder of each media document listed.

21. The combination according to claim 1 wherein means are provided for said at least one user to electronically transfer monetary funds to at least one copyright holder of at least one said media document in order to purchase said at least one said media document,
and wherein said database records all such said transfers of monetary funds,
and wherein at least one user, using the said accessing mode of said application, can access at least one said listing arranged according to number of purchases made of each media document listed.

22. The combination according to claim 1 wherein means are provided to allow the said at least one user, using the said accessing mode of said application, to conduct at least one standard textual search in order to further specify the type of media documents desired.
